(19) United States
(12) Patent Application Publication
(10) Pub. No.: US 2015/0271987 A1
(43) Pub. Date: Oct. 1, 2015

(54) Seeding composition with dispensing apparatus

(71) Applicants: Bryan Foster, Santa Barbara, CA (US); Andrew Tobias, Santa Barbara, CA (US)

(72) Inventors: Bryan Foster, Santa Barbara, CA (US); Andrew Tobias, Santa Barbara, CA (US)

(21) Appl. No.: 14/545,701

(22) Filed: Jun. 8, 2015

Related U.S. Application Data
(63) Continuation-in-part of application No. 13/999,295, filed on Feb. 7, 2014.
(60) Provisional application No. 62/120,285, filed on Feb. 24, 2015.

(51) Int. Cl. A01C 7/00; B65D 83/06; C09D 105/00; C09D 129/04; A01C 1/06; C09D 105/04

(52) U.S. Cl. CPC A01C 7/004; A01C 1/06; C09D 105/04; C09D 105/00; C09D 129/04; B65D 83/06

(57) ABSTRACT

A system for coating seeds with the composition containing a foaming agent and color indicator and related dispensing apparati.

### RELATED APPLICATION

This application is a continuation-in-part of U.S. patent Ser. No. 13/999,295 filed on Feb. 7, 2014 entitled “Seeding Composition with Color and Foaming Indicators” and is related to U.S. Provisional Application Ser. No. 62/120,285 filed on Feb. 28, 2015 entitled “Fluid Dispensing Regulator”.

### BACKGROUND OF THE INVENTION

1. Field of the Invention

The present invention relates to a formulation, composition, system and related methods for coating seeds with color and foaming indicators and related dispensing device with regulator. More specifically, it relates to a kit for dispensing a seed coating compositions having tacking agents, foaming agents, soil surfactants, and color indicators. In addition, the present invention relate to fluid dispensing mechanism and, more particularly, to a regulator that enables a generally more uniform concentration of solids and liquids of fluid mixture to be dispensed from fluid dispensing mechanisms.

2. Description of the Related Art

Conventional fluid dispensing mechanisms are well known and have been in use for a number of years. Regrettably, with most conventional fluid dispensing mechanisms, a rate of flow of solids that are buoyant in a solid and liquid fluid mixture from a container such as a canister is high. As a specific example, the rate of flow of seeds in a water/seed fluid mixture exiting from canister via known nozzle apparatuses is much higher at the beginning of the process where within only a short duration, all seeds are exhausted from the canister and what remains flowing is water. The disadvantage of high rate of flow of solids in solid/liquid fluid mixtures is that the solids (e.g., seeds) dispensed concentrated over and cover a very small fraction of a desired area of coverage. This would mean that for a typical garden area for example, only a small portion of the area of the garden would receive high concentration of seeds, leaving the remaining portions of the garden without seeding. Further, the high level of concentrations of seeds in a small area may impede healthy seed growth.

Therefore, in light of the current state of the art and the drawbacks to current fluid dispensing mechanisms, a need exists for a regulator that would regulate the amount of flow of solids in a fluid mixture at a more general, uniform concentration per rate of flow of fluid and solid or mixtures.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1A is perspective view of the dispensing or nozzle apparatus and canister;

FIG. 1B is an overhead view of the internal cavity of the nozzle apparatus;

FIG. 1C is an overhead view of a regulator in the internal cavity of the nozzle apparatus;

FIG. 1D is a perspective view of a regulator in the canister;

FIG. 2A is an overhead view of a regulator;

FIG. 2B is an overhead view of a regulator;

FIG. 3A is a graph of distribution of solids with and without a regulator;

FIG. 3B is a graph of distribution of solids with and without a regulator;

FIG. 4 is an overhead view of a regulator;

FIG. 5A is a perspective view of a regulator;

FIG. 5B is a perspective view of a regulator;

FIG. 5C is a perspective view of a multi-piece regulator;

FIG. 5D is a perspective view of a regulator;

FIG. 6A is a perspective view of a regulator in the nozzle apparatus;

FIG. 6B is a perspective view of a regulator in the nozzle apparatus; and

FIG. 6C is a perspective view of a regulator in the canister.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### SUMMARY OF THE INVENTION

In one embodiment, the present invention relates to a composition comprising at least one tacking agent, at least one foaming agent, at least one soil surfactant, and at least one color indicator.

In another embodiment, the tacking agent is selected from a group consisting essentially of naturally occurring and synthetic thickeners including but not limited to clays, bentonites, carboxymethyl cellulose (CMC), hydroxymethyl cellulose (HMC), hydroxy propyl methyl cellulose, guar, xantham, cellulose, locust bean, acacia, carrageenan, pullulan, konjac, alginate, cassein, collagen, and castor oil, polyacrylates, polyurethanes, polystyrene/butadienes, polyvinyl alcohols and combinations and mixtures thereof. For purposes of this invention, the term tacking agent is defined as any material or substance that allows at least two materials to attach to or adhere to one another.

In yet another embodiment, the foaming agent is selected from a group consisting essentially of anionic and nonionic surfactants, including but not limited to sulfonated linear alcohols, sulfonated alkyl aromatic alcohols; sulfonated linear alcohol ethoxylates, sulfonated alkyl aryl ethoxylates, alkyl ethoxylates, arylalkyl ethoxylates and mixtures and combinations thereof. For purposes of this invention, the term foaming agent is defined as any material or substance which reduces the surface tension of a liquid and facilitates the trapping of pockets of gas in liquid. In another embodiment, the alcohols are C12-18.

In still another embodiment, the soil surfactant is selected from a group consisting essentially of nonionic and anionic surfactants, alkyl ethoxylates, alkyl aryl ethoxylates, alkyl sulfates, aromatic sulfates, alkyl sulfonates, aromatic sulfonates and combinations and mixtures thereof. For purposes of this invention, the term soil surfactant is defined as any compound or substance which lowers the interfacial tension between a liquid and solid and allows for increased spreadability and wettability.

In still yet another embodiment, the color indicator is selected from a group consisting essentially of colorants, pigments, dyes, triphenylmethane, based acid dyes and phthalocyanine based reactive dyes, and combinations and mixtures thereof. For purposes of this invention, the term color indicator is defined as any material or substance that imparts color or uses color to indicate function or activity.

In a further embodiment, the composition further comprises seeds and the tacking agent adhere seeds to the soil.

In yet a further embodiment, the foaming agent and the color indicator are designed to act as indicators showing where the composition was applied. In still a further embodiment, the soil surfactant assist in allowing water to penetrate through the soil and holds moisture in and around the seeds for seed growth.

In still yet a further embodiment, the composition further comprises wetting agent. In another further embodiment, the wetting agent is water.

In yet another further embodiment, the composition is admixed with the seeds to coat the seeds prior to planting.

In still another further embodiment, the tacking agent is from about 10% to about 50%, said foaming agent is from about 10% to about 30%, said soil surfactant is from about 1% to about 10% said moisturizing agent is from about 1.5% to about 6%, and said color indicator is from about 10% to about 30% of said composition.

In another embodiment, the foaming agent is designed to act as an indicator by creating a foaming effect in area where the composition has been applied.

In yet another embodiment, the present invention relates to a composition manufactured by a process comprising: admixing at least one tacking agent, at least one foaming agent, at least one soil surfactant, and at least one color indicator.

In still another embodiment, the composition is admixed with seeds and the seeds are coated with the composition.

In still yet another embodiment, the composition coated seeds are designed to be planted in a desired area. In a further embodiment, the composition coated seeds are designed to be provided with a wetting agent and in yet a further embodiment, the wetting agent is water.

In still a further embodiment, the foaming agent creates foam to indicate where the composition coated seeds had been planted.

In still yet a further embodiment, the color indicator creates color to indicate where the composition coated seeds had been planted.

In another embodiment, the present invention provides for a method of manufacturing a coating composition for treating seeds, and the method comprises: admixing at least one tacking agent, at least one foaming agent, at least one soil surfactant, and at least one color indicator. In yet another embodiment, the composition is designed to be combined with seeds prior to planting.

In a further embodiment, the present invention relates to system for coating seeds, and the system comprises a formulation and said formulation comprises: at least one foaming agent and at least one color indicator and the composition is designed to be combined with seeds prior to planting.

In yet a further embodiment, the formulation further comprises seeds.

In another further embodiment, system further comprises a device for admixing the formulation with the seeds. In still a further embodiment, the device is designed to dispense the formulation coated seeds. In another embodiment, the device admixing occurs prior to dispensing.

In a further embodiment, the present invention also relates to a composition dispensing system, the system comprises: a dispensing apparatus comprising two opposing ends, a bottom portion and an internal cavity, one end comprising a nozzle for receiving a liquid source and a second end comprising a first opening for dispensing a composition, and the bottom portion having a second opening for receiving a canister; a regulator situated within said dispensing apparatus, the regulator is intended to control flow of a composition; and a composition comprising at least one tacking agent, at least one foaming agent, at least one soil surfactant, and at least one color indicator, said composition is placed within the canister, and the composition is driven from the canister through the second opening into the internal cavity and dispensed through the first opening using the liquid source.

In another further embodiment, the regulator comprises an outer ring, a central opening, and at least two fins, each of the fins has opposing ends, a first free end which forms the central opening, and a second end connected to the outer ring.

In yet a further embodiment, each of the fins is separated by a vane, and the vanes lead to secondary openings along the outer ring. In still a further embodiment, the fins have a flat surface; a curved surface and/or a bent surface.

In still yet a further embodiment, the tacking agent of the composition is selected from a group consisting essentially of naturally occurring thickeners, synthetic thickeners, clays, bentonites, carboxymethyl cellulose (CMC), hydroxymethyl cellulose (HMC), hydroxy propyl methyl cellulose, guar, xantham, cellulose, locust bean, acacia, carrageenan, pullulan, konjac, alginate, cassein, collagen, and castor oil, polyacrylates, polyurethanes, polystyrene/butadienes, polyvinyl alcohols and combinations and mixtures thereof.

In a further embodiment, the foaming agent of the composition is selected from a group consisting essentially of anionic surfactants, nonionic surfactants, sulfonated linear alcohols, sulfonated alkyl aromatic alcohols; sulfonated linear alcohol ethoxylates, sulfonated alkyl aryl ethoxylates, alkyl ethoxylates, arylalkyl ethoxylates and mixtures and combinations thereof.

In another further embodiment, the soil surfactant of the composition is selected from a group consisting essentially of nonionic and anionic surfactants, alkyl ethoxylates, alkyl aryl ethoxylates, alkyl sulfates, aromatic sulfates, alkyl sulfonates, aromatic sulfonates and combinations and mixtures thereof.

In yet another further embodiment, the color indicator of the composition is selected from a group consisting essentially of colorants, pigments, dyes, triphenylmethane, based acid dyes and phthalocyanine based reactive dyes, and combinations and mixtures thereof. In still yet another further embodiment, the system further comprises seeds. In another embodiment, the composition is admixed with the seeds to coat the seeds prior to planting.

In yet another embodiment, the method for admixing and dispensing a composition, the method comprises: providing a dispensing apparatus comprising at least one regulator, two opposing ends, a bottom portion and an internal cavity, one end comprising a nozzle for receiving a liquid source and a second end comprising a first opening for dispensing a composition, the bottom portion having a second opening for receiving a canister; admixing at least one tacking agent, at least one foaming agent, at least one soil surfactant, and at least one color indicator in the canister to form a composition; driving said composition from the canister through the second opening into said internal cavity; and dispensed said composition through the first opening using the liquid source to direct the composition to a targeted area.

In still another embodiment, the regulator is utilized to control the flow of composition. In still yet another embodiment, the regulator comprises an outer ring, a central opening, and at least two fins, each of the fins has opposing ends, a first free end which forms the central opening, and a second end connected to the outer ring.

In still yet another embodiment, each of the fins is separated by a vane, and the vanes lead to secondary openings along the outer ring.

In a further embodiment, the method further comprises admixed seeds with the composition and allowing the seeds to be coated with the composition. In another further embodiment, the composition coated seeds are designed to be planted in a desired area using the dispensing apparatus and the regulator. In yet another further embodiment, the liquid is water and the liquid source is a hose. In still yet another further embodiment, the canister attaches to the dispensing apparatus and the dispensing apparatus comprises a mechanism for activating and deactivating the liquid source flow through said nozzle.

In another embodiment, the system for dispensing grass seed composition having a foaming agent and color indicator, the system comprises: a dispensing apparatus comprising a nozzle for receiving a water source; at least one regulator, an opening for dispensing a composition, and a canister, said canister attaches to said nozzle apparatus; and a composition comprising seeds, at least one tacking agent, at least one foaming agent, at least one soil surfactant, and at least one color indicator, and the composition is distributed to a targeted area using the dispensing apparatus and the composition coated seeds identify the target area using a foaming and color indicator. In another further embodiment, the regulator functions to control the flow of the distribution of the composition coated seeds.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Throughout the disclosure, the term fluid may be construed as any substance, material, or mixture (e.g., water and seed mixture) that has no fixed shape and yields to external pressures. Non-limiting examples of fluids may include mixture of water and seed, gases, fluidized solids (slurries), etc., or combinations thereof.

In general, it is well known that certain solids that are buoyant in certain liquids generally stay afloat or rise to the top of a fluid mixture such as water/seed mixtures where seeds afloat to the top of the water. This would mean that most (if not all), floating solids are generally concentrated at a top of the fluid mixture while the remaining portion of the fluid mixture may have little or no solids or seeds. In other words, the concentration of buoyant solids in the fluid mixture is not uniform throughout the mixture, but mostly concentrated at the top of the fluid. Therefore, in accordance one or more embodiments of the present invention, it has been found that due to buoyancy of solids, the rate of flow of solids such as seeds in the water/seed fluid mixture exiting from canister is much higher at the beginning of the process where within only a short duration, all seeds are exhausted from the canister and what remains flowing is water.

That is, one or more embodiments of the present invention discovered that since high concentration of seeds float and are at the top of the fluid mixture, then most of the seeds at the top are expelled quickly when fluid mixture is dispensed, leaving water for the remainder of the fluid mixture. Therefore, one or more embodiments of the present invention provide a regulator (or disrupting mechanism) that would allow fluid and in particular, concentration of seeds afloat a top of a fluid mixture be disrupted, to thereby dispensed at a more uniform concentration of sold/liquid mixture per rate of flow.

Accordingly, one or more embodiments of the present invention provide regulator disruptors that disburse (or disturb) the concentration of floating solids at the top of a mixture to provide a more homogeneous liquid/solid mixture prior to ejection through a nozzle apparatus, which lowers the amount of seeds expelled per rate of flow of fluid.

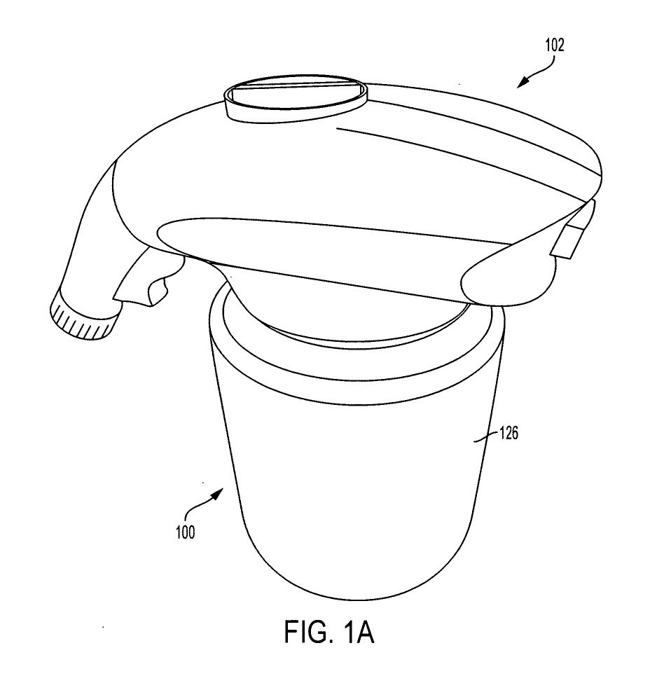

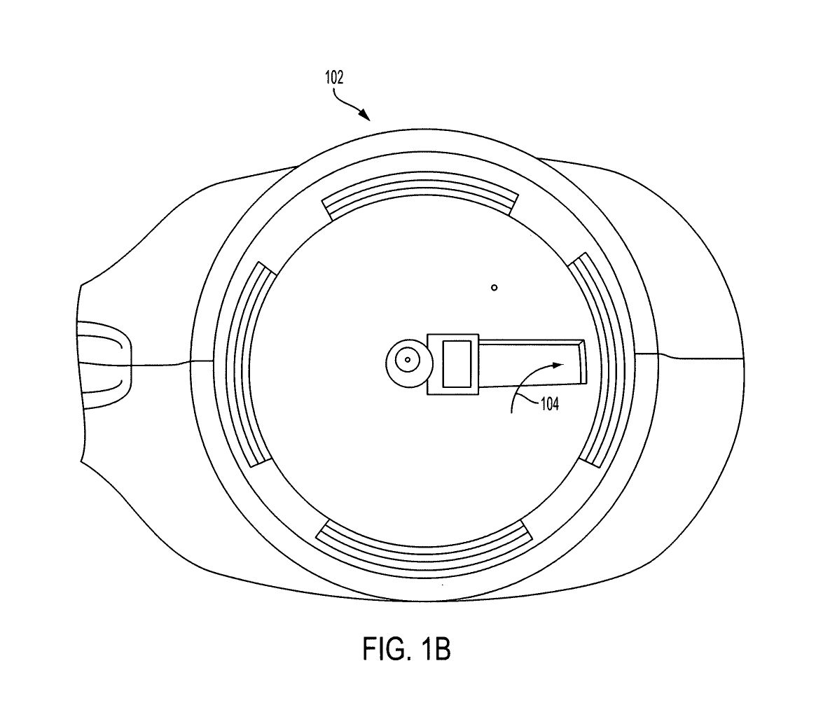

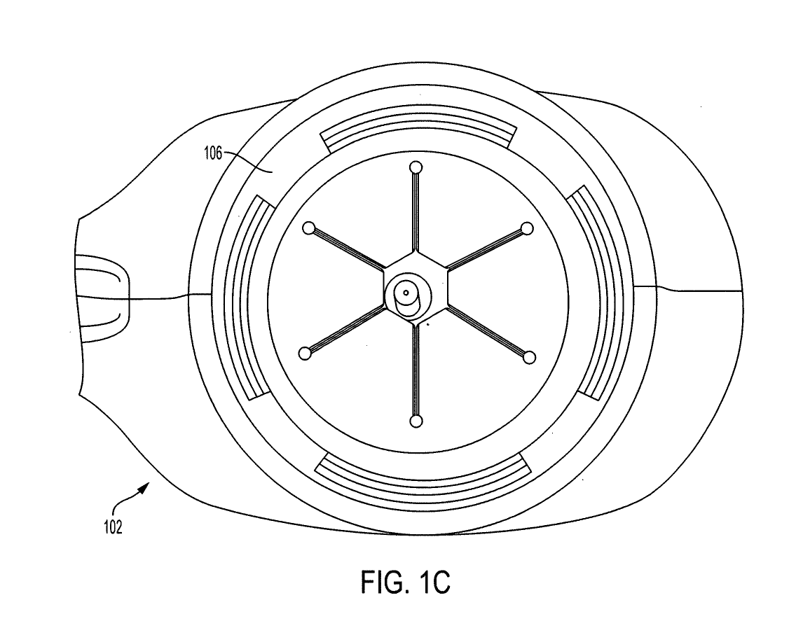

FIG. 1A is a non-limiting, exemplary illustration of fluid dispensing mechanism that includes a regulator in accordance with one or more embodiments of the present invention. As illustrated, the fluid dispensing mechanism 100 includes a canister (or container) 126 that may hold fluid to be dispensed through a nozzle apparatus 102.

As illustrated in FIG. 1B, dispensing or nozzle apparatus 102 includes various inlet/outlet chambers, passages, channels, etc. that funnel and enable flow 104 of fluid from canister 126 and out through nozzle apparatus 102.

FIG. 1C is a non-limiting, exemplary illustration of a nozzle apparatus shown in FIGS. 1A and 1B that includes a regulator in accordance with one or more embodiments of the presented invention. It should be noted that although regulator 106 is illustrated as being associated with nozzle apparatus 102, regulator 106 may instead be associated with any part of fluid dispensing mechanism 100 (best shown in FIG. 1D) so long as regulator 106 is position within a flow stream 104 of the fluid and prior to the final egress point of the fluid, which would facilitate in regulating flow.

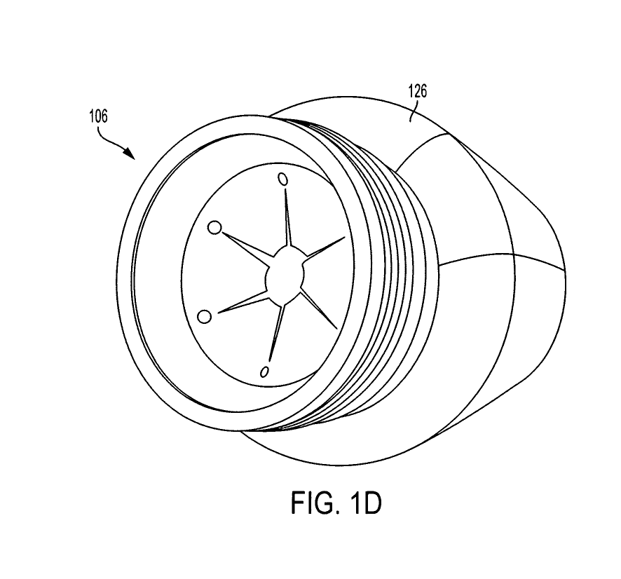

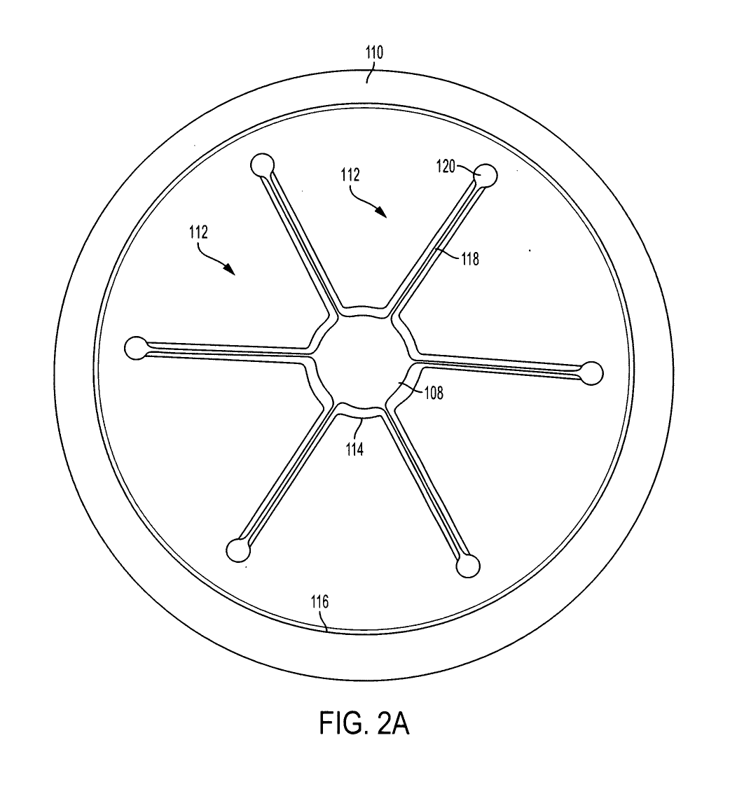

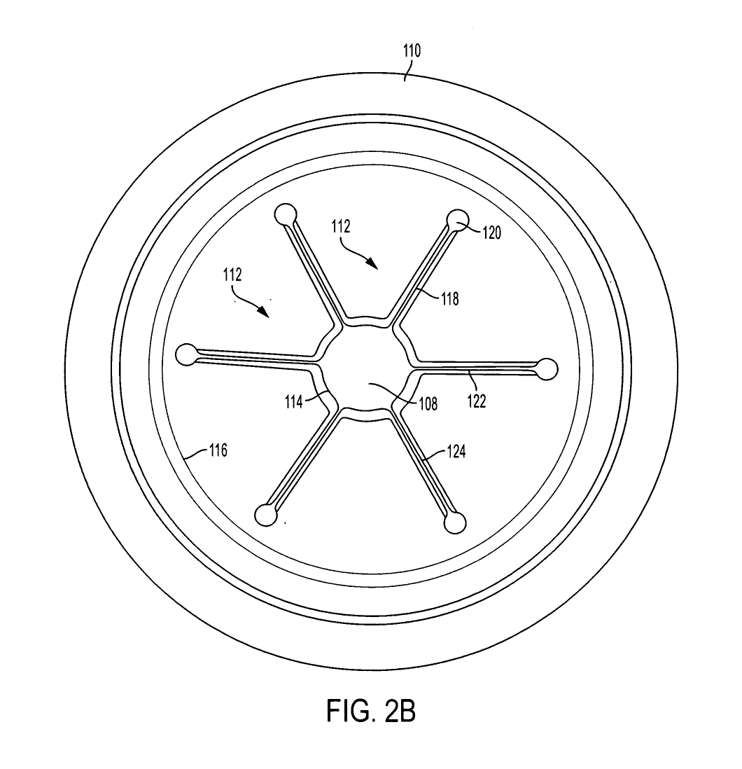

FIGS. 2A and 2B are non-limiting, exemplary illustration of a regulator in accordance with one or more embodiments of the present invention. As illustrated, the regulator is comprised of a single piece member 106 having at least one perforation 108, defining a through-hole opening of sufficient size to enable passage of a solid particle of 10 a fluid. Single piece member 106 may further include a securing structure 110 that enables detachably positioning member 106 within the flow stream 104 of the fluid.

Single piece member 106 includes agitator fins or vanes 112 that may move (e.g., flap) independently as a result of fluid pressure impinged on their surfaces, which vibrates the vanes and facilitates further agitation of fluid. Mixing of the fluid facilitates in “breaking” or disbursing the floated concentrations of seeds. Further, the vanes 112 block high levels of concentrated seed from passing into the final outlet of nozzle apparatus, which result in a more uniform solid/liquid mixture exiting the outlet and further, a slower rate of outflow of the solids of the fluid mixture. Agitator vanes 112 are cantilevered in a radial pattern having a first free end 114 that define a first opening 108 of the member 106, and a second end 116 that is an extension of the member 106 toward the radial center. A single agitator vane 112a and a next, adjacent agitator vane 112b is separated by a slit 118 that extends from first opening 108 and leads to a second opening 120.

First free ends 114 of agitator vanes 112 have a shorter, curved span, defining a circular opening 108, while second end 116 of agitator vanes 112 have a wider span, forming a quadrilateral shape, with three free sides 114, 122, and 124 to enable independent movement of agitator vanes 112. Agitator vanes 112 are cantilevered at a slope, forming a generally conical configuration, with an inlet-facing side (FIG. 1D-1) being convex and outlet-facing side (FIG. 1D-2) concave.

Positioning regulator 106 within a flow stream of a fluid, impedes 5 flow of solids within a fluid mixture from being expelled from an outlet when they impinge agitator vanes 112 under fluid pressure, and further, when expelled, solid/liquid mixture ratio is generally more uniform. As a further note, as liquid is introduced into the canister 126, solids stay afloat or rise to the top of a fluid mixture, with most floating solids generally concentrated at the top of the fluid mixture while the remaining portion of the fluid mixture may have little or no solids. As canister 126 receives more liquid, the fluid level within the canister 126 continues to rise, raising the elevation of concentration of solids afloat at the top of the liquid. As the solids rise, they eventually rich high elevation within the canister and impinge against the agitator vanes 112. The vanes 112 block and disrupt the floating concentration of solids at the top of the fluid mixture, allowing only smaller concentrations of solids (a more “diluted” fluid) to pass into a “secondary chamber” defined by outlet-facing (concave) side of the regulator 106. This dispersing action of the floating concentration of solids enables dispensing of the solids of the fluid mixture at a slower rate and at a more uniform concentration of sold/liquid mixture per rate of flow. Accordingly, the slower rate of flow of solids in the fluid mixture exiting from canister 126 is at a longer duration, where solids are no longer quickly exhausted from the canister. That is, by breaking the highly concentrated solids afloat at the top of the liquid in accordance with one or more embodiments of the present invention, most of the solids are generally more disbursed throughout the fluid mixture and expelled at a more uniform and slower rate.

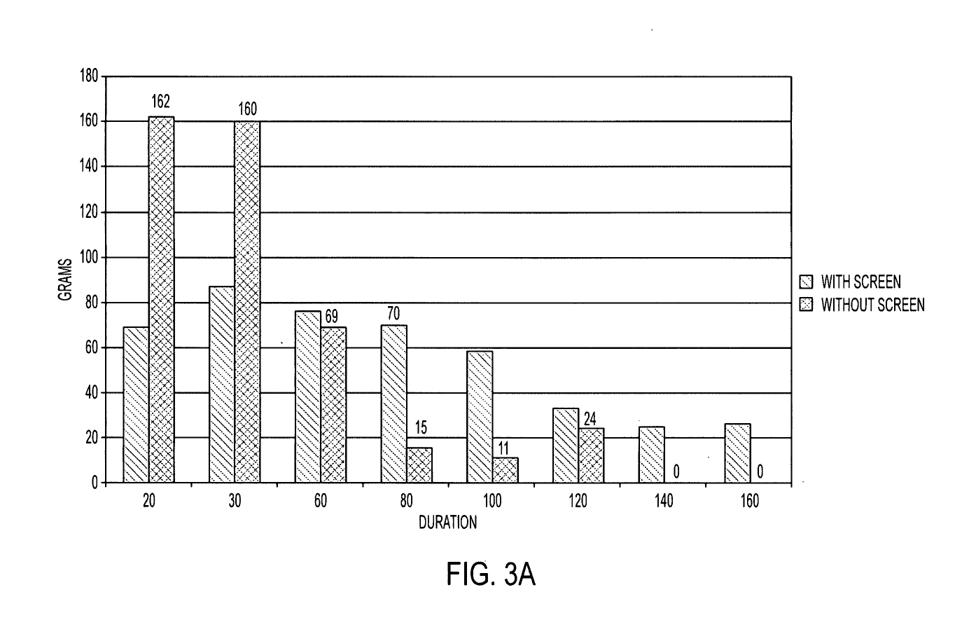

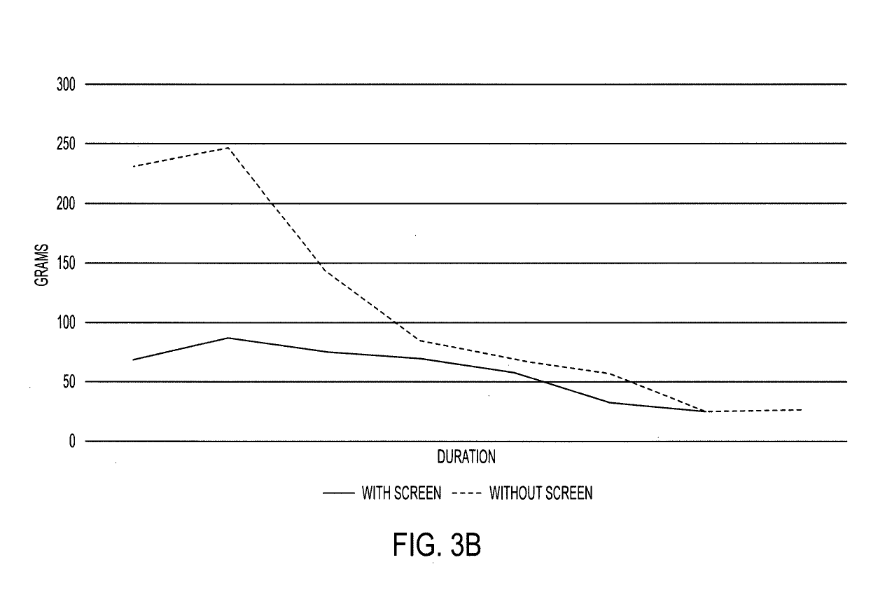

FIGS. 3A and 3B are non-limiting, exemplary illustrations of exemplary graphs (bar graph and line graph) that illustrate a slower rate of flow of solids in a fluid mixture in accordance with one or more embodiments of the present invention. As illustrated in FIGS. 3A and 3B, without using regulator 106, the duration solids of a fluid mixture exhausted from canister 126 is very short, where almost all solids are expelled at a very short time whereas with the use of the regulator, there is a much more uniform rate of flow of solids in the fluid mixture through time.

FIG. 4 is non-limiting, exemplary illustrations of a regulator in accordance with one or more embodiments of the present invention. The regulator 400 illustrated in FIG. 4 includes similar corresponding or equivalent components, interconnections, functional, operational, and or cooperative relationships as the regulator 106 that is shown in FIGS. 1A to 3B, and described above. Therefore, for the sake of brevity, clarity, convenience, and to avoid duplication, the general description of FIG. 4 will not repeat every corresponding or equivalent component, interconnections, functional, operational, and or cooperative relationships that has already been described above in relation to regulator 106 that is shown in FIGS. 1A to 3B. As illustrated, in this non-limiting, exemplary instance, the regulator 400 further includes undulating vanes 402, which further facilitate in agitating to disburse floated concentration of solids of a fluid. It should be noted that the vanes 112 need not have an undulated configuration and may instead be comprised of irregular protuberances and shapes, so long as the configurations further aid in mixing to disburse floating solid concentrations.

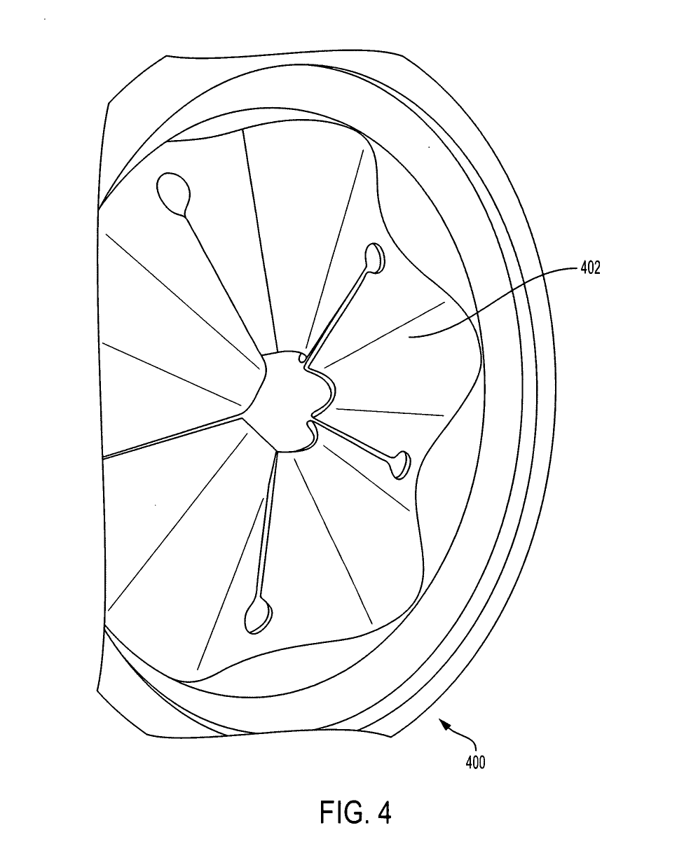

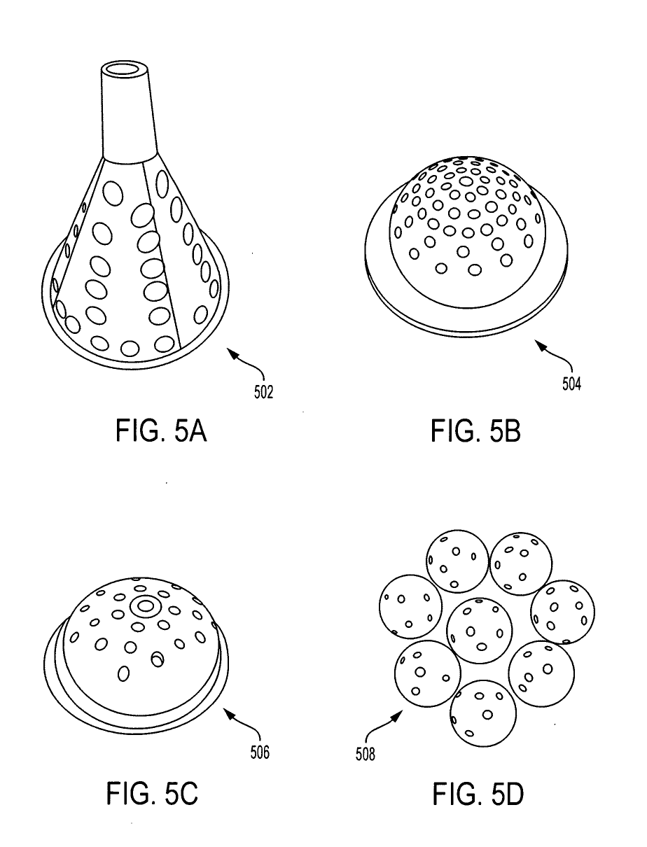

FIGS. 5A to 5D are non-limiting, exemplary illustrations of a regulator in accordance with one or more embodiments of the present invention. The regulators 502 to 508 illustrated in FIGS. 5A to 5D include similar corresponding or equivalent components, interconnections, functional, operational, and or cooperative relationships as regulators 106 and 400 that are shown in FIGS. 1A to 4, and described above. Therefore, for the sake of brevity, clarity, convenience, and to avoid duplication, the general description of FIGS. 5A to 5D will not repeat every corresponding or equivalent component, interconnections, functional, operational, and or cooperative relationships that has already been described above in relation to regulators 106 and 400 that are shown in FIGS. 1A to 4. As illustrated, in this non-limiting, exemplary instance, the regulators 502 to 508 are comprised of various structures that may be rigid or flexible that when positioned within the fluid “break” the concentrated solids floating at the top of the fluid with the help of incoming fluid flowing into the canister, and further include holes within which to “trap” solids, slowing flow rate of solids.

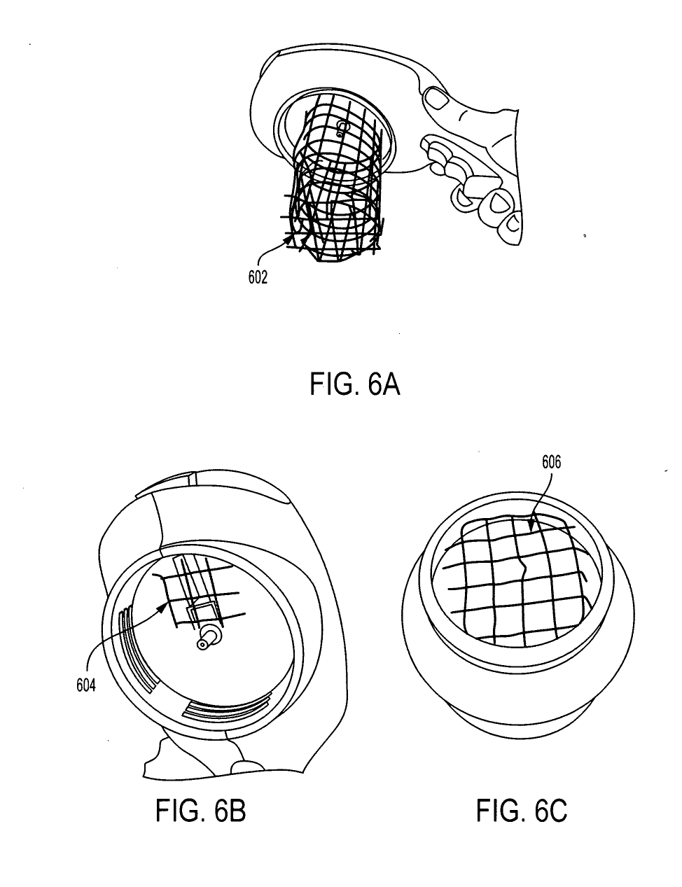

FIGS. 6A to 6C are non-limiting, exemplary illustrations of a regulator in accordance with one or more embodiments of the present invention. The regulators 602 to 606 illustrated in FIGS. 6A to 6C include similar corresponding or equivalent components, interconnections, functional, operational, and or cooperative relationships as regulators 106, 400, and 502-508 that are shown in FIGS. 1A to 5D, and described above.

Therefore, for the sake of brevity, clarity, convenience, and to avoid duplication, the general description of FIGS. 6A to 6C will not repeat every corresponding or equivalent component, interconnections, functional, operational, and or cooperative relationships that has already been described above in relation to regulators 106, 400, and 502-508 that are shown in FIGS. 1A to 5D. As illustrated, in this non-limiting, exemplary instance, the regulators 602 to 606 are comprised of meshes that are positioned in a flow stream of a fluid, impeding flow of solids within a fluid mixture from being expelled from an outlet when they impinge the meshes under fluid pressure, and further, when expelled, solid/liquid mixture ratio is generally maintained at uniform rate.

The present invention also relates to a composition and system for coating seeds with indicators showing where the seeds were planted. The following are numerous examples of various embodiments of the present invention and this application is not limited to these examples.

### EXAMPLE 1

In one example, the present invention utilizes arginate as the tacking agent, a sulfonated linear alcohol as a foaming agent and an acid dye as a color indicator. The ingredients and % range of the ingredient in the composition is set forth below in Table 1.

TABLE 1

| Ingredients: | Function: | % Range |
|---|---|---|
| Alginate | Tacking Agent | 10-50 |
| Sulfonated linear alcohol | Foaming Agent | 10-30 |
| Alkyl Sulfonate | Soil Surfactant | 1-10 |
| Acid Dye | Color Indicator | 10-30 |

### EXAMPLE 2

In another example, the present invention utilizes guar as the tacking agent, a sulfonated linear alcohol as a foaming agent and a reactive dye as a color indicator. The ingredients and % range of the ingredient in the composition is set forth below in Table 2.

TABLE 2

| Ingredients: | Function: | % Range |
|---|---|---|
| Guar | Tacking Agent | 10-50 |
| Sulfonated linear alcohol | Foaming Agent | 10-30 |
| Alkyl Ethoxylate | Soil Surfactant | 1-10 |
| Reactive Dye | Color Indicator | 10-30 |

### EXAMPLE 3

In yet another example, the present invention utilizes polyvinyl alcohol as the tacking agent, a sulfonated linear ethoxalate as a foaming agent and a pigment as a color indicator. The ingredients and % range of the ingredient in the composition is set forth below in Table 3.

TABLE 3

| Ingredients: | Function: | % Range |
|---|---|---|
| Polyvinyl alcohol | Tacking Agent | 10-50 |
| Sulfonated linear ethoxalate | Foaming Agent | 10-30 |
| Alkyl Sulfate | Soil Surfactant | 1-10 |
| Pigment | Color Indicator | 10-30 |

### EXAMPLE 4

In still another example, the present invention utilizes alcinate as the tacking agent, a sulfonated linear ethoxalate as a foaming agent and an acid dye as a color indicator. The ingredients and % range of the ingredient in the composition is set forth below in Table 4.

TABLE 4

| Ingredients: | Function: | % Range |
|---|---|---|
| Alcinate | Tacking Agent | 10-50 |
| Sulfonated linear ethoxalate | Foaming Agent | 10-30 |
| Alkyl aryl ethoxalate | Soil Surfactant | 1-10 |
| Acid Dye | Color Indicator | 10-30 |

### EXAMPLE 5

In still yet another example, the present invention utilizes alcinate, guar or polyvinyl alcohol (or mixtures thereof) as the tacking agent, a sulfonated linear alcohol as a foaming agent and a dye as a color indicator. The ingredients and % range of the ingredient in the composition is set forth below in Table 5.

TABLE 5

| Ingredients: | Function: | % Range |
|---|---|---|
| Alcinate, guar, polyvinyl alcohol or mixtures | Tacking Agent | 10-50 |
| Sulfonated linear alcohol | Foaming Agent | 10-30 |
| Dye | Color Indicator | 10-30 |

The various compositions described in Examples 1-5 are designed to be admixed, combined or used as coatings for seeds.

In one embodiment, the composition containing the tacking agent, foaming agent, soil surfactant and color indicator are placed in a container with the seeds and are allowed to be admixed thereby coating the seeds. The container is designed to receive a water source such as a hose and the container is designed with a venturi effect which sprays the newly coated seed from the nozzle to exactly where you want to plant a new lawn.

The tacking agent allows the composition to attach to the seeds. The color indicator and foaming agent indicates where the coated seeds have been sprayed or applied to the desired area. The soil surfactant is a substance that reduces the surface tension of a liquid, causing the liquid to spread across or penetrate more easily the surface of a solid, opening up the soil allowing water to flow through. Water penetration and saturation is extremely important in home lawns as most lawns have compaction areas that increase over time, as the soil is not being cultivated and is left in a compacted state. The ability for soil surfactant to bond water with soil particles allows the soil to become wet and hold water in the area that has just been seeded, ultimately keeping moisture in and around the soil aiding in seed germination and growth.

Therefore, the foregoing is considered as illustrative only of the principles of the invention. Further, since numerous modifications and changes will readily occur to those skilled in the art, it is not desired to limit the invention to the exact composition and operation shown and described, and accordingly, all suitable modifications and equivalents may be resorted to, falling within the scope of the invention.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A composition dispensing system, said system comprising:
a dispensing apparatus comprising two opposing ends, a bottom portion and an internal cavity, one end comprising a nozzle for receiving a liquid source and a second end comprising a first opening for dispensing a composition, said bottom portion having a second opening for receiving a canister;
a regulator situated within said dispensing apparatus, said regulator is intended to control flow of a composition; and
a composition comprising at least one tacking agent, at least one foaming agent, at least one soil surfactant, and at least one color indicator, said composition is placed within said canister, said composition is driven from said canister through said second opening into said internal cavity and dispensed through said first opening using the liquid source.

2. The system of claim 1 wherein said regulator comprises an outer ring, a central opening, and at least two fins, each of said fins has opposing ends, a first free end which forms said central opening, and a second end connected to said outer ring.

3. The system of claim 2 wherein each of said fins is separated by a vane, said vanes lead to secondary openings along said outer ring.

4. The system of claim 2 wherein said fins have a flat surface.

5. The system of claim 2 wherein said fins have a curved surface.

6. The system of claim 5 wherein said fins have a bent surface.

7. The system of claim 1 wherein said tacking agent of said composition is selected from a group consisting essentially of naturally occurring thickeners, synthetic thickeners, clays, bentonites, carboxymethyl cellulose (CMC), hydroxymethyl cellulose (HMC), hydroxy propyl methyl cellulose, guar, xantham, cellulose, locust bean, acacia, carrageenan, pullulan, konjac, alginate, cassein, collagen, and castor oil, polyacrylates, polyurethanes, polystyrene/butadienes, polyvinyl alcohols and combinations and mixtures thereof.

8. The system of claim 1 wherein said foaming agent of said composition is selected from a group consisting essentially of anionic surfactants, nonionic surfactants, sulfonated linear alcohols, sulfonated alkyl aromatic alcohols; sulfonated linear alcohol ethoxylates, sulfonated alkyl aryl ethoxylates, alkyl ethoxylates, arylalkyl ethoxylates and mixtures and combinations thereof.

9. The system of claim 1, wherein said soil surfactant of said composition is selected from a group consisting essentially of nonionic and anionic surfactants, alkyl ethoxylates, alkyl aryl ethoxylates, alkyl sulfates, aromatic sulfates, alkyl sulfonates, aromatic sulfonates and combinations and mixtures thereof.

10. The system of claim 1, wherein said color indicator of said composition is selected from a group consisting essentially of colorants, pigments, dyes, triphenylmethane, based acid dyes and phthalocyanine based reactive dyes, and combinations and mixtures thereof.

11. The system of claim 1 further comprising seeds.

12. The system of claim 1 wherein said foaming agent and said color indicator acts as indicators showing where said composition was applied.

13. The system of claim 1 wherein said tacking agent adhere seeds to the soil

14. The system of claim 1 wherein said soil surfactant assist in allowing water to penetrate through the soil and holds moisture in and around said seeds for seed growth.

15. The system of claim 11 wherein said composition is admixed with said seeds to coat said seeds prior to planting.

16. A method for admixing and dispensing a composition, said method comprising:
providing a dispensing apparatus comprising at least one regulator, two opposing ends, a bottom portion and an internal cavity, one end comprising a nozzle for receiving a liquid source and a second end comprising a first opening for dispensing a composition, said bottom portion having a second opening for receiving a canister;
admixing at least one tacking agent, at least one foaming agent, at least one soil surfactant, and at least one color indicator in said canister to form a composition;
driving said composition from said canister through said second opening into said internal cavity; and
dispensed said composition through said first opening using the liquid source to direct said composition to a targeted area.

17. The method of claim 16 wherein said regulator is utilized to control said flow of composition.

18. The method of claim 16 wherein said regulator comprises an outer ring, a central opening, and at least two fins, each of said fins has opposing ends, a first free end which forms said central opening, and a second end connected to said outer ring.

19. The method of claim 17 wherein each of said fins is separated by a vane, said vanes lead to secondary openings along said outer ring.

20. The method of claim 16 wherein said tacking agent is selected from a group consisting essentially of naturally occurring thickeners, synthetic thickeners, clays, bentonites, carboxymethyl cellulose (CMC), hydroxymethyl cellulose (HMC), hydroxy propyl methyl cellulose, guar, xantham, cellulose, locust bean, acacia, carrageenan, pullulan, konjac, alginate, cassein, collagen, and castor oil, polyacrylates, polyurethanes, polystyrene/butadienes, polyvinyl alcohols and combinations and mixtures thereof.

21. The method of claim 16 wherein said foaming agent is selected from a group consisting essentially of anionic surfactants, nonionic surfactants, sulfonated linear alcohols, sulfonated alkyl aromatic alcohols; sulfonated linear alcohol ethoxylates, sulfonated alkyl aryl ethoxylates, alkyl ethoxylates, arylalkyl ethoxylates and mixtures and combinations thereof.

22. The method of claim 16 wherein said soil surfactant is selected from a group consisting essentially of nonionic and anionic surfactants, alkyl ethoxylates, alkyl aryl ethoxylates, alkyl sulfates, aromatic sulfates, alkyl sulfonates, aromatic sulfonates and combinations and mixtures thereof.

23. The method of claim 16 wherein said color indicator is selected from a group consisting essentially of colorants, pigments, dyes, triphenylmethane, based acid dyes and phthalocyanine based reactive dyes, and combinations and mixtures thereof.

24. The method of claim 16 wherein said composition further comprises seeds.

25. The method of claim 24 further comprising admixed seeds with said composition and allowing said seeds to be coated with said composition.

26. The method of claim 16 wherein said composition coated seeds are designed to be planted in a desired area using said dispensing apparatus and said regulator.

27. The method of claim 16 wherein said liquid is water.

28. The method of claim 16 wherein said liquid source is a hose.

29. The method of claim 16 wherein said canister attaches to said dispensing apparatus and said dispensing apparatus comprises a mechanism for activating and deactivating said liquid source flow through said nozzle.

29. A system for dispensing grass seed composition having a foaming agent and color indicator, said system comprising:
a dispensing apparatus comprising a nozzle for receiving a water source; at least one regulator, an opening for dispensing a composition, and a canister, said canister attaches to said nozzle apparatus; and
a composition comprising seeds, at least one tacking agent, at least one foaming agent, at least one soil surfactant, and at least one color indicator, said composition is distributed to a targeted area using said dispensing apparatus and said composition coated seeds identify the target area using a foaming and color indicator.

30. The system of claim 29 wherein said regulator functions to control the flow of the distribution of the composition coated seeds.
